(19) United States
(12) Patent Application Publication
(10) Pub. No.: US 2026/0232045 A1
(43) Pub. Date: Aug. 13, 2026

(54) SYSTEMS AND METHODS FOR POWERING A PORTABLE INHALATION DEVICE WITHOUT BATTERY POWER

(71) Applicant: Past Patterns, LLC, Santa Barbara, CA (US)

(72) Inventors: DAVIS KIYONAGA, Santa Barbara, CA (US); Evan Abel, Rockaway Park, NY (US)

(21) Appl. No.: 19/456,829

(22) Filed: Jan. 22, 2026

Related U.S. Application Data
(60) Provisional application No. 63/756,128, filed on Feb. 8, 2025.

(51) Int. Cl. A24F 47/00; A24F 40/40; H02J 7/00

(52) U.S. Cl. CPC A24F 47/00; A24F 40/40; H02J 7/342; H02J 7/855; H02J 2207/50

(57) ABSTRACT

An example adapter device includes a power-side connector configured to be coupled to a power source. A device-side connector can be configured to be coupled to a portable inhalation device. A power adapter can condition electricity received from the power source such that the electricity is usable by the portable inhalation device. For example, the portable inhalation device can use the conditioned electricity from the power adapter, rather than chemical-battery power, to vaporize a substance for inhalation. In another example, an example device is provided for powering a portable inhalation device without using a chemical-based battery, such as by utilizing a capacitor that stores energy received from the power source and dispenses the stored energy to the portable inhalation device to vaporize a material for inhalation.

### PRIORITY

This application claims priority to U.S. Provisional Patent App. No. 63/756,128, filed Feb. 8, 2025, entitled “SYSTEMS AND METHODS FOR POWERING A PORTABLE INHALATION DEVICE WITHOUT BATTERY POWER,” and which is hereby incorporated by reference in its entirety herein.

### BACKGROUND

Portable inhalation devices have become increasingly popular in recent years as an alternative to traditional smoking methods. These devices typically utilize electronic components to heat and vaporize a substance for inhalation, providing users with a potentially less harmful and less conspicuous method of consumption compared to combustion-based smoking. The portable nature of these devices allows for convenient use in various settings, making them attractive to a wide range of consumers.

Conventional portable inhalation devices often rely on rechargeable batteries as their primary power source. While this approach offers mobility and convenience, it also presents several challenges. Battery life limitations can lead to interrupted usage, requiring frequent recharging or battery replacement. The inclusion of batteries in these devices adds to their overall weight and size, potentially impacting user comfort and portability. Additionally, the use of batteries contributes to electronic waste, raising environmental concerns as the number of these devices in circulation continues to grow.

Furthermore, the integration of batteries into portable inhalation devices increases their complexity and manufacturing costs. The need for battery management systems and charging circuits adds to the overall component count and design intricacy. This complexity may lead to higher retail prices for consumers and increased potential for device malfunctions or failures.

As the demand for portable inhalation devices continues to rise, there is a growing need for alternative power solutions that address these limitations. A power delivery method that eliminates the reliance on internal batteries while maintaining the functionality and convenience of these devices could potentially revolutionize the industry. Such an approach can simplify device design, reduce manufacturing costs, and minimize electronic waste associated with battery disposal.

Moreover, there is a need for power solutions that can leverage existing infrastructure and widely available power sources. With the ubiquity of USB ports, standardized power outlets, and mobile devices with substantial battery capacity, an opportunity exists to develop inhalation devices that can seamlessly integrate with these common power delivery systems. This integration could potentially enhance user convenience and reduce the need for specialized charging equipment.

### SUMMARY

In an example embodiment, an adapter device for powering a portable inhalation device is provided. The adapter device can include a power-side connector configured to be coupled to a power source and a device-side connector configured to be coupled to the portable inhalation device. The adapter device can include a power adapter configured to condition electricity received from the power source such that the electricity is usable by the portable inhalation device. The portable inhalation device can use the conditioned electricity from the power adapter, rather than chemical-battery power, to vaporize a substance for inhalation.

As described in more detail below, the portable inhalation device and adapter device can be housed in a singular device. In some examples, this combined device is referred to as a portable inhalation device or just a device. In other examples however, the portable inhalation device can be a cartridge that houses vaporizable material for inhalation or a vaporizer device configured to vaporize material for inhalation. For example, the cartridge can include a reservoir containing a liquid substance. The vaporizer device can include an atomizer assembly with a heating element. The heating element can convert the conditioned electricity into thermal energy, which then vaporizes the substance for user inhalation.

In some examples, the power source is a mobile phone. For example, the mobile phone can provide electrical power through a USB port. The power adapter can be configured to determine a threshold energy-draw rate from the mobile phone and receive power from the mobile phone in accordance with the threshold. This can prevent the adapter device from drawing excessive current that could damage the mobile phone or trigger protective circuits.

The adapter device can be connected to the portable inhalation device and/or the power source using a power cable or internal circuitry. Where a cable is used, the cable can allow the portable inhalation device to be used at a distance from the power source. The power cable can be permanently fixed to at least one of the power-side connector and the power source in an embodiment, and in another embodiment the power cable can be detachable to allow for different cable lengths or replacement.

The adapter device can be positioned within a body portion of the portable inhalation device. For example, the power adapter circuitry can be integrated into the housing of the inhalation device. This integration can create a more compact form factor. The integrated design can eliminate external adapter components. The portable inhalation device can include a heating element that receives the conditioned electricity directly from the integrated power adapter through integrated circuitry rather than an external power cable.

In an example embodiment, a device for powering a portable inhalation device without using a chemical-based battery can include a power-side connector configured to be coupled to a power source and a device-side connector configured to be coupled to the portable inhalation device. The device can include a capacitor configured to store energy received from the power source and dispense the stored energy to the portable inhalation device. The portable inhalation device can be configured to vaporize a material based on the stored energy dispersed from the capacitor.

The capacitor can provide instantaneous high-current delivery for vaporization. For example, the capacitor can charge slowly from the power source. The capacitor can then discharge rapidly to power the heating element, either while still connected to the power source or after being disconnected therefrom. This can allow the power source to have lower current capacity while still supporting high-power vaporization. The capacitor can be at least one of a super capacitor, dielectric capacitor, electrolytic capacitor, and ceramic capacitor, for example. The capacitor can be positioned within a body portion of the portable inhalation device. For example, the capacitor can be integrated alongside the heating element and reservoir in a compact housing.

In another example, a method is provided for powering a portable inhalation device without battery power by coupling an adapter device to a power source. The method can include conditioning, by the adapter device, electricity received from the power source. The method can include providing the conditioned electricity to a portable inhalation device. The portable inhalation device can use the conditioned electricity from the power adapter, rather than battery power, to vaporize a substance for inhalation.

In one example, the method can include decoupling the adapter device from the power source before providing the conditioned electricity to the portable inhalation device. For example, the adapter device can store energy in a capacitor while coupled to the power source. The adapter device can then be disconnected from the power source. The stored energy in the capacitor can power the portable inhalation device after disconnection. Providing the conditioned electricity can be performed by a capacitor that was charged while the adapter was coupled to the power source.

The example method can include determining a threshold power draw rate for the power source. For example, the adapter device can communicate with the power source to identify maximum current capacity. The adapter device can detect the power source type based on electrical characteristics. Conditioning electricity can include drawing electricity from the power source at a rate that does not exceed the threshold power draw rate for the power source. This can prevent overloading the power source or triggering protective shutdowns.

The method can include trickle-charging the adapter device by the power source. For example, the power source can provide a continuous low-current charge to a capacitor in the adapter device. The trickle charge can maintain the capacitor at full capacity while compensating for self-discharge of the capacitor when needed. The method can include inserting a power cord into at least one of the adapter device and the power source. The power cord can provide the electrical connection between the power source and the adapter device to charge the capacitor at a low-current that does not generate excessive heat or damage the circuitry of the device or the power source, such as a phone.

Both the foregoing general description and the following detailed description are exemplary and explanatory only and are not restrictive of the examples, as claimed.

### BRIEF DESCRIPTION OF THE DRAWINGS

FIG. 1 is a flowchart of an example method for powering a portable inhalation device without battery power according to one or more embodiments herein.

FIG. 2 is a flowchart of an example method for powering a portable inhalation device without battery power according to one or more embodiments herein.

FIG. 3 is an exploded view of an example cartridge adapter according to one or more embodiments herein.

FIG. 4 is an exploded view of an example direct connect cartridge according to one or more embodiments herein.

FIG. 5 is a block diagram of an example device powered by an external power source according to one or more embodiments herein.

FIG. 6 is a block diagram of an example device powered by an external power source according to one or more embodiments herein.

FIG. 7 is a perspective view of an example device capable of being powered by an external power source according to one or more embodiments herein.

FIG. 8A is a perspective view of an example device capable of being powered by an external power source according to one or more embodiments herein.

FIG. 8B is another perspective view of the example device of FIG. 8A according to one or more embodiments herein.

FIG. 9A a perspective view of an example device capable of being powered by an external power source according to one or more embodiments herein.

FIG. 9B is another perspective view of the example device of FIG. 9A according to one or more embodiments herein.

FIG. 10 is an exploded view of various components within the example device of FIGS. 9A and 9B.

### DETAILED DESCRIPTION

Reference will now be made in detail to the present examples, including examples illustrated in the accompanying drawings.

The present disclosure relates to systems, methods, apparatus, and devices for powering portable inhalation devices without relying on internal rechargeable batteries, particularly chemical-based batteries such as lithium ion or alkaline batteries. In various examples, the invention can eliminate battery-dependent architectures by utilizing capacitive energy storage and/or adaptive power management circuitry. The invention can enable portable inhalation devices to operate when coupled to power-limited sources such as smartphones, tablets, laptop computers, and other USB-compliant devices that impose strict power output limitations, or when plugged directly into a typical household electrical outlet.

Traditional portable inhalation devices can rely on rechargeable lithium-ion batteries as their primary energy storage mechanism. These battery-based systems can present several limitations including limited cycle life, safety concerns related to thermal runaway, environmental disposal challenges, and incompatibility with low-power USB outputs from modern smartphones. Modern smartphones, particularly iPhones, can impose strict power output limitations such as a maximum of 4.5 watts for USB power-compliant accessories. When accessories attempt to draw excessive current, the smartphone can trigger protection mechanisms and display an error, thereby preventing operation and protecting the device from potential damage.

The present invention can solve these problems by providing a battery-less vaporization device that conditions and directly provides power from a power source to a vaporization component, and/or employs capacitive energy storage elements such as capacitors, super-capacitors, or dielectric capacitors. The device can detect power output limitations of connected power sources, condition incoming electricity to remain within allowable power draw thresholds, implement trickle charging to slowly accumulate energy in capacitive storage elements, decouple from the power source before or during vaporization events, and discharge stored capacitive energy to generate sufficient heat for vaporization without drawing excessive instantaneous current from the power source.

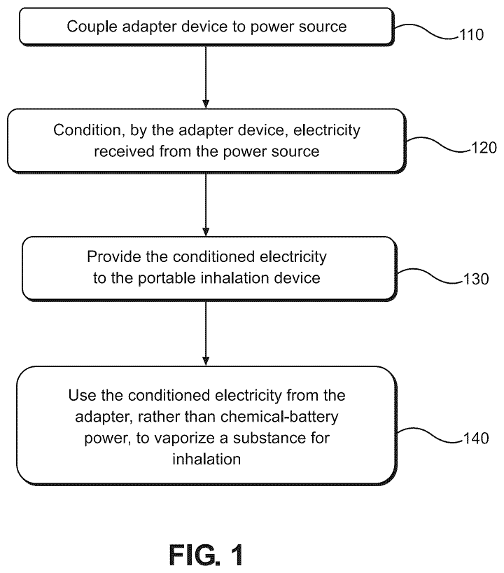

FIG. 1 provides a flowchart of an example method for powering a portable inhalation device without battery power according to one or more embodiments herein, which can enable a portable inhalation device to operate using conditioned electricity from an external power source rather than relying on chemical-battery power.

Stage 110 can include coupling an adapter device to a power source. In an example, a user can perform this stage by connecting the adapter device to an external power source such as a USB port, wall outlet, or other standard power source. The adapter device can feature various types of power-side connectors to facilitate this coupling, such as a direct USB connector, a corded USB connector, or flip-out prongs for direct wall outlet connection. The power source can be any device capable of providing electrical power, including but not limited to smartphones such as iPhones or Android devices, tablet computers, laptop computers, desktop computers, USB wall adapters, portable power banks, or vehicle USB charging ports. The coupling can establish both a mechanical connection and an electrical connection between the adapter device and the power source.

In some examples, the adapter device can include an attached cable permanently or removably connected to the device body. The attached cable can terminate in a connector configured to mate with the power source, such as a USB-C plug for modern devices, a Lightning connector for iPhone compatibility, a USB-A plug for legacy compatibility, or a proprietary magnetic connector. The cable can have a length that provides flexibility in positioning the device relative to the power source. In other examples, the adapter device can include a port such as a USB-C receptacle configured to accept an external cable provided by the user. This configuration can allow the user to select a cable of appropriate length and type for their specific use case.

Stage 120 can include conditioning, by the adapter device, electricity received from the power source. In an example, a power adapter within the adapter device can perform this stage by regulating the input power to ensure appropriate voltage and current delivery to the portable inhalation device. The conditioning can involve converting the external power source output, such as 5V USB power, to power requirements suitable for the portable inhalation device's heating element. The power adapter can include power conditioning circuitry configured to detect power output limitations of the connected power source and adjust the power draw accordingly.

The power conditioning circuitry can implement several functions to ensure safe and effective operation. The circuitry can detect a power output limit of the power source by monitoring voltage levels, current draw, and communication signals from the power source, For example, when connected to an iPhone, the circuitry can detect that the maximum available power is approximately 4.5 watts based on USB Power Delivery negotiation protocols. The circuitry can then configure itself to draw power within this limitation to avoid triggering the phone's protection mechanisms that would display an error message and disconnect the accessory.

The power conditioning circuitry can condition electricity received from the power source to remain within the allowable power draw threshold. This can involve current limiting circuitry that restricts the instantaneous current draw to a safe level, such as 900 milliamps or less for a 5-volt USB source. The circuitry can also implement voltage regulation to convert the input voltage to an appropriate level for charging capacitive storage elements. In some examples, the circuitry can include a converter to step down voltage, a linear regulator for precise voltage control, or a switched-mode power supply for efficient power conversion.

Stage 130 can include providing the conditioned electricity to the portable inhalation device. In an example, the power adapter can perform this stage by delivering the regulated power to a device-side connector of the adapter device. The device-side connector can be designed to interface with standard cartridges used in portable inhalation devices, such as those with 510 threading, magnetic connections, or proprietary pod connections. The conditioned electricity can flow from the power conditioning circuitry through the device-side connector to the heating element of the portable inhalation device.

Stage 140 can include using the conditioned electricity from the power adapter, rather than chemical-battery power, to vaporize a substance for inhalation. In an example, the portable inhalation device can perform this stage by utilizing the conditioned electricity to power its heating element, which vaporizes the substance contained within a reservoir. The heating element can be a resistive heating coil, ceramic heater, or mesh coil configured to convert electrical energy into thermal energy. When electrical current flows through the heating element, the resistance of the element can cause it to heat up rapidly, reaching temperatures typically between 180° C. and 220° C. suitable for vaporizing common inhalation substances.

The vaporization process can occur when a user activates the device, either by pressing an activation button or by inhaling through a mouthpiece which triggers a draw sensor. Upon activation, the device can discharge stored energy from the capacitive storage elements through the heating element. The discharge can occur over a period of approximately 1 to 10 seconds, providing sufficient power to heat the element and vaporize the substance. The vaporized substance can then be carried by airflow through the device to the mouthpiece where the user can inhale it.

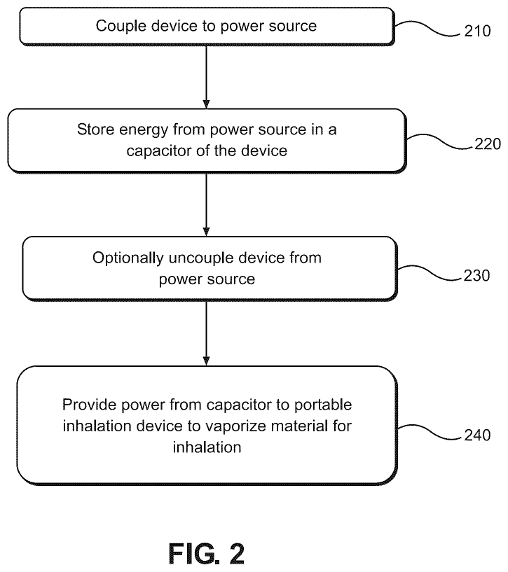

FIG. 2 provides a flowchart of an example method for storing energy in a capacitor and providing power from the capacitor to a portable inhalation device according to one or more embodiments herein. This method can enable operation from power-limited sources by accumulating energy over time in capacitive storage elements, for example.

Stage 210 can include coupling a device to a power source. This stage can be similar to stage 110 described above, where a user connects the device to an external power source such as a USB port or wall outlet. The device can include power conditioning circuitry and one or more capacitive storage elements configured to accumulate electrical energy from the power source.

Stage 220 can include storing energy from the power source in a capacitor of the device. In an example, the power conditioning circuitry can perform this stage by implementing a trickle charging mode. During trickle charging, the device can draw a limited amount of current from the power source over an extended period, slowly accumulating energy in the capacitor. The trickle charging mode can be particularly useful when the power source has strict power output limitations, such as a smartphone that can provide only 4.5 watts maximum.

The capacitor can be any type of capacitive storage element suitable for storing electrical energy, including electrolytic capacitors, super-capacitors, ultracapacitors, or dielectric capacitors. In some examples, the device can include multiple capacitors arranged in series, parallel, or a combination thereof to achieve desired voltage and capacitance characteristics. The capacitor can store energy in an electric field between conductive plates, allowing for rapid charge and discharge cycles without the chemical degradation associated with batteries.

The trickle charging process can continue until the capacitor reaches a predetermined charge level, such as 80% or 90% of its maximum rated voltage, or a level aligned with the power needs of vaporization components within the device. The power conditioning circuitry can monitor the capacitor voltage and adjust the charging current accordingly. As the capacitor voltage approaches the maximum, the charging current can be reduced to prevent overcharging. The time required to fully charge the capacitor can depend on the capacitor's capacitance, the power source's output capability, and the efficiency of the power conditioning circuitry. In some examples, charging can take from 10 seconds to 5 minutes.

Stage 230 can include optionally uncoupling the device from the power source. This stage can be performed by the user physically disconnecting the device from the power source, or can occur automatically when the device detects that the capacitor has reached a sufficient charge level. In some examples, the device can remain connected to the power source during operation, allowing for continuous trickle charging between vaporization events. In other examples, the device can be designed for portable use after charging, similar to how a battery-powered device operates, but with the advantage of much faster charging times and longer cycle life.

When the device is uncoupled from the power source, the capacitor can retain its stored charge for a period of time determined by the capacitor's self-discharge rate and any leakage currents in the device circuitry. Super-capacitors and ultracapacitors can have relatively high self-discharge rates compared to batteries, potentially losing a significant portion of their charge over hours or days. However, for devices intended for frequent use, this self-discharge may not be a significant limitation, particularly when power sources such as phones or tablets are readily available.

Stage 240 can include providing power from the capacitor to the portable inhalation device to vaporize material for inhalation. In an example, when the user activates the device, the power conditioning circuitry can control the discharge of the capacitor through the heating element. The discharge can be controlled using switching circuitry such as MOSFETs or other solid-state switches that can rapidly open and close to regulate the current flow.

The power delivered to the heating element during discharge can be significantly higher than the power drawn from the power source during charging. For example, the device may draw only 3 to 4 watts from a smartphone during trickle charging but can deliver 20 to 50 watts to the heating element during discharge. This power amplification can be achieved because the energy accumulated slowly over time in the capacitor can be released rapidly during the brief vaporization period.

The discharge process can be controlled to maintain a relatively constant power delivery to the heating element despite the decreasing voltage of the capacitor as it discharges. This can be accomplished using pulse-width modulation (PWM) or other control techniques that adjust the duty cycle of the switching circuitry to compensate for the voltage drop. The discharge can continue until the user deactivates the device, the capacitor voltage drops below a minimum threshold, or a maximum discharge duration is reached for safety reasons.

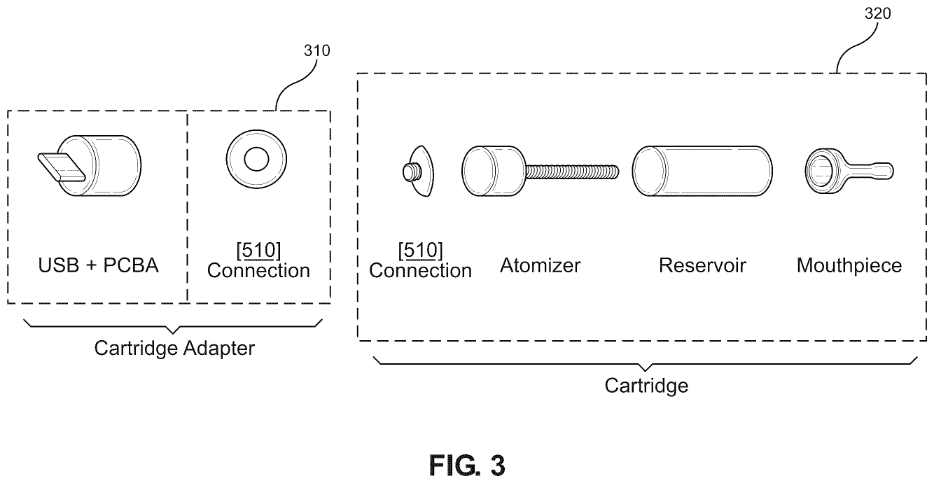

FIG. 3 shows an example embodiment that includes a cartridge adapter 310 as well as a standard cartridge 320. In some examples, the standard cartridge 320 can be an existing cartridge design that can be purchased off the shelf. The cartridge 320 can include a connector, such as a 510-thread connector, an atomizer, a reservoir, and a mouthpiece. When a user pulls air through the mouthpiece, air can enter the atomizer and a small amount of the substance within the reservoir can be atomized for inhalation. The 510 connection can typically be used to connect a battery to the cartridge.

However, in this embodiment, a cartridge adapter 310 can be provided. The example cartridge adapter 310 does not have a battery. Instead, the example cartridge adapter 310 can be shown as a singular unit that includes a power connector (in this example, a USB connector) and an integrated PCBA for conditioning the power appropriately for the cartridge 320. As shown in the figure, a portion of the cartridge adapter 310 can include a 510 connector configured to engage the matching 510 connector of the standard cartridge 320.

It should be noted that although the connector can be described herein as a “510” connector, which is commonly used for cartridges, it need not be limited to this particular type of connector. Instead, any type of connection that provides a physical and electrical connection between the adapter 310 and cartridge 320 can be used. This can include threaded connectors, push pin connectors, friction-fit connectors, magnetic connectors, or any other suitable mechanisms.

The cartridge adapter 310 can include power conditioning circuitry that can regulate the voltage and current supplied to the cartridge 320. This circuitry can ensure that the power delivered to the atomizer within the cartridge 320 can be appropriate for vaporization, regardless of variations in the input power from the external source. The power conditioning circuitry can also implement safety features such as overcurrent protection, overvoltage protection, and thermal management to prevent damage to the device or injury to the user.

In some examples, the cartridge adapter 310 can include one or more capacitive storage elements, such as capacitors or super-capacitors, that can store energy received from the power source. These capacitive storage elements can allow the device to accumulate energy slowly from a power-limited source and then discharge that energy rapidly to the heating element during vaporization. This can enable the device to operate from sources such as smartphones that have strict power output limitations.

The cartridge 320 can include a reservoir that holds the vaporizable substance. The reservoir can be made of glass, plastic, or other suitable materials that can be transparent or translucent to allow the user to see the substance level. The reservoir can be refillable in some examples, allowing the user to add more substance when it runs low. In other examples, the cartridge 320 can be a disposable unit that can be replaced when the substance is depleted.

The atomizer within the cartridge 320 can include a heating element, such as a coil or ceramic element, that can be in contact with a wicking material. The wicking material can draw the vaporizable substance from the reservoir to the heating element through capillary action. When the heating element can be energized, it can heat the substance in the wick to its vaporization temperature, creating vapor that can be inhaled by the user.

The mouthpiece of the cartridge 320 can be designed to provide a comfortable interface for the user to inhale the vapor. The mouthpiece can be made of materials such as plastic, silicone, or metal, and can be shaped to fit comfortably in the user's mouth. In some examples, the mouthpiece can be removable for cleaning or replacement.

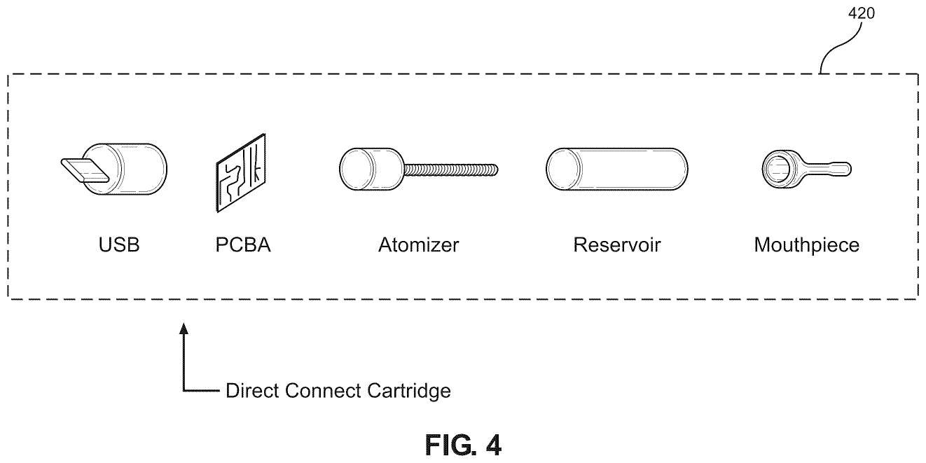

FIG. 4 provides another example embodiment. The embodiment of FIG. 4 is a direct connect cartridge 420. As opposed to the example of FIG. 3, the example cartridge 420 of FIG. 4 is a singular unit that does not require connecting a traditional cartridge to a cartridge adapter. Instead, the direct connect cartridge 420 includes a power connector (labelled “USB”) in FIG. 4, a circuit board labelled “PCBA,” an atomizer, reservoir, and mouthpiece.

In this example, the atomizer, reservoir, and mouthpiece can operate in the same general fashion as the cartridge 320 of FIG. 3. That is, when a user pulls air through the mouthpiece, and air enters the atomizer and a small amount of the substance within the reservoir is atomized for inhalation. However, in this embodiment, the electricity to power the atomizer is provided directly from the power connector to the atomizer through the PCBA. In other words, there is no removable connector provided between the PCBA and atomizer. Instead, the PCBA can be configured to power the atomizer directly, such as by having a hard-wired connection directly to the atomizer.

This design allows for the elimination of adaptors and connectors for connecting a cartridge to a power source. Doing so reduces the complexity and cost of the product, but also reduces the need for a customer to match a power source with a cartridge. For example, a user need not ensure that different parts have matching thread pitch in order to operate a cartridge. At the same time, the design eliminates the downsides of having a battery, providing a smaller, lighter, cheaper, and safer product as a result.

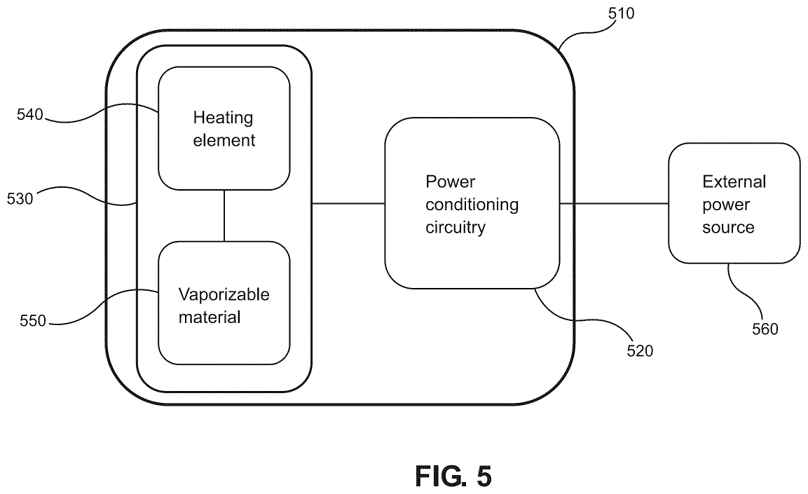

FIG. 5 provides a block diagram of an example battery-less vaporization system according to one or more embodiments herein. The system can include a device 510 that interfaces with an external power source 560. The device 510 can include power conditioning circuitry 520 that receives electrical power from the external power source 560. The power conditioning circuitry 520 can regulate voltage and current to appropriate levels for operating a portable inhalation device 530.

The portable inhalation device 530 can include a heating element 540 and vaporizable material 550. The heating element 540 can receive conditioned electrical power from the power conditioning circuitry 520. The heating element 540 can convert electrical energy into thermal energy to heat the vaporizable material 550 to a vaporization temperature. The vaporizable material 550 can transition from a liquid or solid state to a vapor state when heated by the heating element 540.

The external power source 560 can be any standardized power delivery system. In some examples, the external power source 560 can be a USB port on a computing device such as a smartphone, tablet computer, laptop computer, or desktop computer. In an example, the USB port provides 5 volts DC at various current capacities depending on the USB specification. For example, USB 2.0 ports can provide up to 500 milliamps, USB 3.0 ports can provide up to 900 milliamps, and USB Power Delivery ports can provide higher currents up to 3 amps or more.

In other examples, the external power source 560 can be a wall outlet providing alternating current at standard voltages such as 120 volts AC in North America or 240 volts AC in other regions. The power conditioning circuitry 520 can include AC-to-DC conversion components to convert the alternating current to direct current suitable for the heating element 540. The external power source 560 can also be a portable power bank, a vehicle USB charging port, or any other power delivery system capable of providing electrical power to the device 510.

The power conditioning circuitry 520 can perform multiple functions to ensure safe and effective power delivery. The circuitry can detect the type and capabilities of the external power source 560. For example, the circuitry can determine whether the power source is a USB 2.0 port with a 500 milliamp limit, a USB 3.0 port with a 900 milliamp limit, or a USB Power Delivery port with higher current capacity. The circuitry can also negotiate with the power source using USB Power Delivery protocols to request optimal power levels.

The power conditioning circuitry 520 can regulate the voltage received from the external power source 560 to a voltage level appropriate for the heating element 540. In some examples, the heating element 540 can operate at voltages between 3 and 5 volts. The power conditioning circuitry 520 can include voltage regulation components such as buck converters, linear regulators, or switching regulators to step down higher input voltages or step up lower input voltages to the target voltage level.

The power conditioning circuitry 520 can also limit the current drawn from the external power source 560 to remain within the power source's capabilities, This current limiting function can prevent the device 510 from triggering overcurrent protection mechanisms in the power source. For example, when connected to a phone that can provide a maximum of 900 milliamps, the power conditioning circuitry 520 can limit the current draw to 800 milliamps or less to provide a safety margin.

The heating element 540 can be a resistive heating element that generates heat when electrical current flows through it. The heating element 540 can be constructed from materials such as stainless steel, wire made from other metals or alloys, ceramic, or other materials with appropriate electrical resistance and thermal properties. The resistance of the heating element 540 can determine the power consumption when a given voltage is applied.

The vaporizable material 550 can be any substance intended for inhalation. In some examples, the vaporizable material 550 can be a liquid containing propylene glycol, vegetable glycerin, flavorings, and/or optionally nicotine or other active ingredients, In other examples, the vaporizable material 550 can be cannabis oil containing cannabinoids such as THC or CBD. The vaporizable material 550 can be contained in a reservoir within the portable inhalation device 530 and can be delivered to the heating element 540 through a wick or other transport mechanism.

The system shown in FIG. 5 can operate without an internal battery. Instead of storing energy in a chemical battery, the device 510 can receive power directly from the external power source 560 during operation. This direct power delivery approach can eliminate the need for battery charging circuits, battery management systems, and the battery itself. The elimination of the battery can reduce device weight, simplify device construction, reduce manufacturing costs, and eliminate environmental concerns associated with battery disposal.

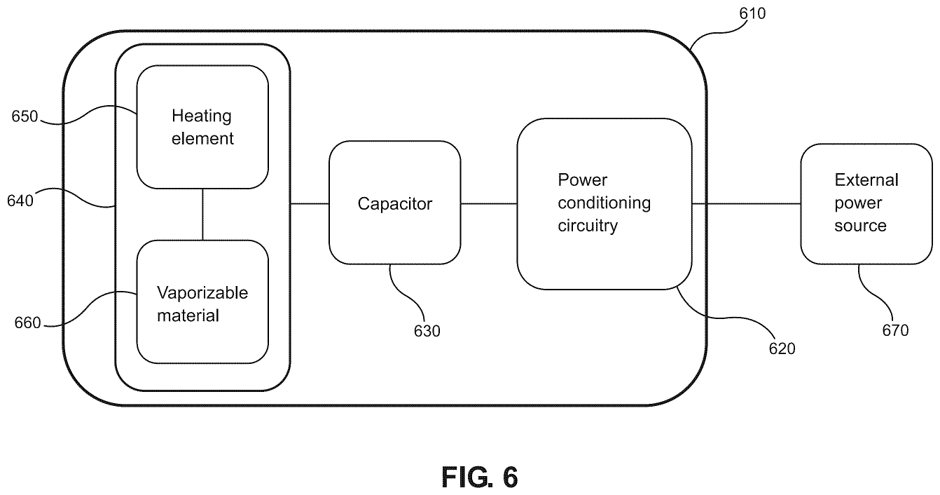

FIG. 6 provides a block diagram of an example battery-less vaporization system according to one or more embodiments herein. The system can include a device 610 that interfaces with an external power source 670. The device 610 can include power conditioning circuitry 620 that receives electrical power from the external power source 670. The power conditioning circuitry 620 can regulate voltage and current to appropriate levels for operating a portable inhalation device 640. The portable inhalation device 640 can be the same or similar to the portable inhalation device 530 described with respect to FIG. 5. Similarly, the external power source 670 can be the same or similar to the external power source 560 described with respect to FIG. 5.

In an example, the device 610 of FIG. 6 includes a capacitor 630 as shown. The capacitor 630 can store energy received from the power source 670 and dispense the stored energy to the portable inhalation device 640. The capacitor 630 can enable the device to accumulate energy slowly over time from a power-limited source and then discharge that energy rapidly to the heating element 650 during vaporization. This can allow the device to operate from sources such as smartphones that have strict power output limitations.

The capacitor 630 can be any type of capacitive storage element suitable for storing electrical energy. In some examples, the capacitor 630 can be a super-capacitor, also known as an ultracapacitor or electric double-layer capacitor. Super-capacitors can store significantly more energy than conventional capacitors and can provide high power output during discharge. In other examples, the capacitor 630 can be a dielectric capacitor, which uses a dielectric material between conductive plates to store energy in an electric field. Dielectric capacitors can include ceramic capacitors, film capacitors, or other types. In yet other examples, the capacitor 630 can be an electrolytic capacitor, which uses an electrolyte to achieve a larger capacitance per unit volume. Any type of capacitor that provides suitable energy storage and dissipation in the ranges required to operate a portable inhalation device can be used.

The device 610 can implement a “trickle charging” mode to slowly accumulate energy in the capacitor 630. During trickle charging, the device can draw a limited amount of current from the power source 670 over an extended period. For example, if the power source can provide a maximum of 4.5 watts, the device can draw 3 watts continuously to charge the capacitor 630. By way of example, over a period of 30 seconds to several minutes, the capacitor 630 can accumulate sufficient energy to power a vaporization session lasting several seconds.

The power conditioning circuitry 620 can monitor the voltage across the capacitor 630 to determine the charge state. When the capacitor voltage reaches a predetermined level, such as 80% or 90% of its maximum rated voltage, the device can signal that it is ready for use. The device can include an indicator light or other user interface element to communicate the charge state to the user.

When the user activates the device for vaporization, the power conditioning circuitry 620 can disconnect from the power source 670 and allow the capacitor 630 to discharge through the heating element 650. This disconnection can be performed internally, such as by disengaging a switch, or can be performed externally by a user, such as by removing a charging cable from the device. The discharge can occur rapidly, providing high instantaneous power to the heating element 650 without drawing excessive current from the power source 670. For example, the capacitor 630 can discharge at 20 to 50 watts for several seconds, which is sufficient to heat the heating element 650 to vaporization temperature, even though the power source 670 may only be capable of providing 4.5 watts continuously.

After the vaporization session, the capacitor 630 can be recharged by reconnecting to the power source 670 through the power conditioning circuitry 620. The device can allow multiple vaporization sessions per full charge of the capacitor 630, depending on the capacitor size and the power requirements of the heating element 650. In some examples, the device can provide 1 to 10 vaporization sessions per full charge.

The device 610 can be configured to operate while connected to the power source 670 or after being disconnected. In some examples, the user can leave the device connected to the power source during use, and the device can continuously trickle charge the capacitor 630 between vaporization sessions. In other examples, the user can charge the device for a period of time, disconnect it from the power source, and then use it for multiple vaporization sessions before needing to reconnect for recharging.

The portable inhalation device 640 can be modular with interchangeable cartridges or pods. The cartridges can include components external to the device 610, such as tanks for holding the vaporizable material 660, heating elements 650, mouthpieces, and in some examples, additional rechargeable power sources. The device 610 can provide the conversion of power to be used for heating with the purpose of inhalation, while the cartridge provides the substance reservoir and heating element. This modular design can allow users to replace cartridges when the vaporizable material is depleted or when they wish to change to a different substance.

In other examples, the device 610 and portable inhalation device 640 can be integrated as an all-in-one device. In this configuration, the power conditioning circuitry 620, capacitor 630, heating element 650, and reservoir for vaporizable material 660 can all be contained within a single housing. The integrated design can provide a more compact form factor and can eliminate the need for connectors between the power delivery components and the heating element.

The system shown in FIG. 6 can provide several advantages over traditional battery-powered vaporization devices. By eliminating the battery, the device can be lighter, smaller, and less expensive to manufacture. The device can also have a longer operational lifetime, as capacitors can withstand many more charge-discharge cycles than batteries without significant degradation. The device can charge more quickly than battery-powered devices, as capacitors can accept charge at higher rates than batteries. The device can also be safer, as capacitors do not pose the same thermal runaway risks as lithium-ion batteries.

In some examples, the device 610 can include multiple capacitors 630 arranged in series, parallel, or a combination thereof to achieve desired voltage and capacitance characteristics. Series connection of capacitors can increase the voltage rating, while parallel connection can increase the total capacitance. The power conditioning circuitry 620 can include cell balancing circuits to ensure that series-connected capacitors charge and discharge evenly, preventing overvoltage on individual capacitors.

The device 610 can be configured to provide feedback to the user regarding the charge state and operational status. An indicator light can display different colors or patterns to indicate charging, fully charged, discharging, or fault conditions. For example, a pulsing green light can indicate charging in progress, a solid green light can indicate fully charged and ready for use, a pulsing blue light can indicate active vaporization, and a red light can indicate a fault condition such as overtemperature or short circuit.

The device 610 can include thermal management features to dissipate heat generated during operation. The power conditioning circuitry 620 can generate heat during voltage conversion, and the heating element 650 can generate significant heat during vaporization. The device housing can include heat sinks, thermal vents, or heat-spreading materials to conduct heat away from sensitive components and prevent overheating. In some examples, the device can include a temperature sensor that monitors the device temperature and reduces power or shuts down if the temperature exceeds a safe threshold.

The capacitor 630 can have a self-discharge rate that causes it to lose charge over time when not connected to a power source. The self-discharge rate can vary depending on the type of capacitor, with super-capacitors typically having higher self-discharge rates than electrolytic capacitors. The device 610 can be designed to account for this self-discharge. In some examples, the device can include a low-power monitoring circuit that periodically checks the capacitor voltage and can alert the user if the charge has dropped below a usable level. In other examples, the device can be designed for frequent use, where the self-discharge is not a significant concern because the device is regularly recharged.

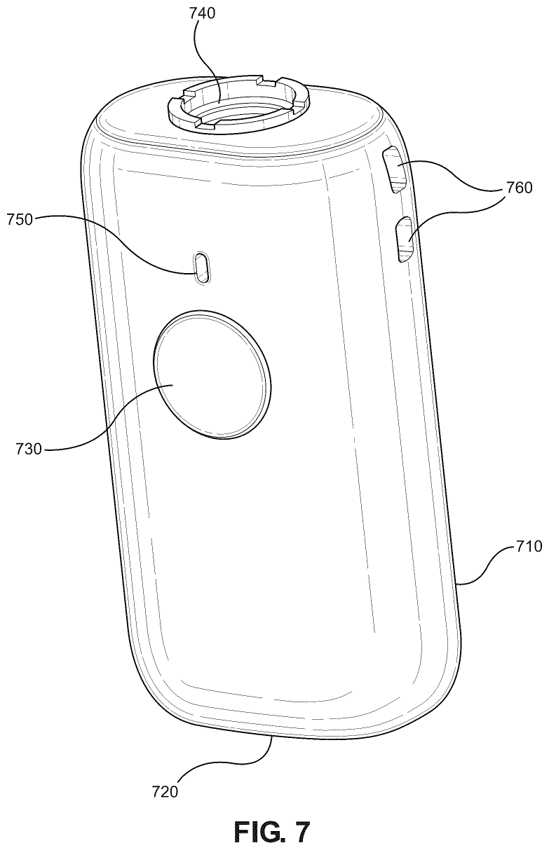

FIG. 7 provides a perspective view of an example handheld device housing that can integrate one or more of the power-management and vaporization features described with respect to FIGS. 1-6. The example of FIG. 7 can illustrate an external form factor for a battery-less vaporization device that can couple to an external power source, condition received power, optionally store energy, and deliver the conditioned or stored energy to a portable inhalation device, while also providing user controls and status indication on an exterior body portion.

In the example device of FIG. 7, a body portion 710 is provided. The body portion 710 can define an exterior shell that encloses internal components such as power conditioning circuitry, one or more capacitors, and in some examples, at least a portion of a portable inhalation device such as a cartridge, pod, or integrated atomizer assembly. For example, the body portion 710 can be formed as a generally elongate housing having rounded corners and a smooth outer contour so that a user can comfortably grip the device in a hand during operation.

The body portion 710 can define an internal cavity. The internal cavity may be configured to receive a circuit board that can carry power conditioning circuitry similar to the circuitry 520 shown in FIG. 5 or the circuitry 620 shown in FIG. 6. The internal cavity can further be configured to receive one or more capacitors similar to the capacitor 630 of FIG. 6. For example, the body portion 710 can include internal mounting features that can support a printed circuit board and mechanically secure one or more capacitors within the device.

A power connector 720 may be positioned at a lower end region of the body portion 710. The power connector 720 can be configured to couple the device of FIG. 7 to an external power source such as the external power source 560 shown in FIG. 5 or the external power source 670 shown in FIG. 6. For example, the power connector 720 can include a USB-type plug that can extend from or be recessed within the body portion 710 and can receive a corresponding USB connector of a phone, tablet, computer, or wall adapter.

In another example, the power connector 720 may include a set of flip-out prongs that can be foldable into the body portion 710 when not in use and can be extendable outwardly for direct connection to a wall outlet. The power connector 720 can be electrically coupled to the internal power conditioning circuitry and, in some examples, to the capacitor within the body portion 710 so that the device may receive, condition, and optionally store energy received from the external power source.

An operation button 730 can be positioned on a front face of the body portion 710. The operation button 730 can be configured to allow a user to control one or more operational states of the device. For example, the operation button 730 can be configured to initiate a vaporization event by causing stored energy in a capacitor to be discharged through a heating element similar to the heating element 540 of FIG. 5 or the heating element 650 of FIG. 6. In another example, the operation button 730 may be configured to trigger a charging mode in which the power conditioning circuitry can draw power from the power connector 720 at a controlled rate, for example using a trickle charging technique similar to that described with respect to FIG. 6. For example, a short press of the operation button 730 can be interpreted as a command to begin a vaporization cycle, whereas a long press can be interpreted as a command to enter or exit a charging-only mode. The operation button 730 can be implemented as a mechanical push-button, a capacitive touch sensor, or another type of user input device. For example, the operation button 730 may be a dome-type tactile switch mounted on the internal circuit board and actuated by a plastic or metal keycap that forms a portion of the outer surface of the body portion 710.

A cartridge connector 740 can be provided at an upper end of the body portion 710. The cartridge connector 740 can be configured to couple the device of FIG. 7 to a portable inhalation device such as a cartridge, pod, or other replaceable reservoir assembly, For example, the cartridge connector 740 can include a threaded interface such as a 510-type connector similar to the connector described with respect to the cartridge adapter 310 and the cartridge 320 of FIG. 3.

In another example, the cartridge connector 740 may include a magnetic coupling structure that can receive a cartridge having a complementary magnetic base as in some of the modular cartridge designs discussed elsewhere in this description. For example, the cartridge connector 740 can include an annular recess that can receive a cylindrical cartridge, with one or more electrical contacts located within the recess to provide positive and negative connections to a heating element contained in the cartridge.

The cartridge connector 740 may be electrically connected to the internal circuit board within the body portion 710. The internal circuit board can route conditioned power or capacitor discharge current from the power conditioning circuitry to the cartridge connector 740 so that a heating element within the attached cartridge can receive appropriate power for vaporization. For example, when the user actuates the operation button 730, the circuit board can close a switching element that connects the capacitor to the cartridge connector 740 to deliver a controlled vaporization pulse.

An indicator light 750 may be provided on the front face of the body portion 710. The indicator light 750 can be configured to provide visual feedback to the user regarding the operational status of the device. For example, the indicator light 750 can illuminate in a first color when the device is coupled to a power source through the power connector 720 and is charging an internal capacitor.

In another example, the indicator light 750 can illuminate in a second color or may flash when the capacitor has reached a predetermined charge state and the device is ready to perform a vaporization event. For example, the indicator light 750 can emit a steady green light when the capacitor voltage reaches a threshold corresponding to a desired energy level, such as the 80% or 90% charge level discussed with respect to FIG. 6.

The indicator light 750 can also be configured to indicate fault conditions. For example, when the power conditioning circuitry detects an overtemperature condition, an overcurrent condition, or a short circuit at the cartridge connector 740, the indicator light 750 can flash in a distinct pattern or may change to a third color to alert the user that operation can be temporarily suspended. The indicator light 750 can be implemented as a single-color LED, a multi-color LED, or a group of LEDs. The indicator light 750 can be driven by the same or similar control circuitry that can drive the indicator lights described for the device 610 of FIG. 6.

One or more adjustment buttons 760 may be provided on a side of the body portion 710. The adjustment buttons 760 can be configured to allow the user to modify operational parameters of the device. For example, the adjustment buttons 760 can be used to select between different power levels or vaporization profiles, such as low, medium, and high heating power.

In another example, the adjustment buttons 760 can be configured to set a duration of a vaporization event. For example, a first press of one of the adjustment buttons 760 may increase a target discharge interval from three seconds to five seconds, while another press can further increase the target interval to eight seconds, up to a predetermined maximum vaporization window.

The adjustment buttons 760 can be coupled to the same microcontroller or logic circuitry that can manage trickle charging, discharge control, and safety monitoring as described in connection with FIGS. 5 and 6. For example, when the user selects a higher power setting using the adjustment buttons 760, the control circuitry can raise a discharge current setpoint for the heating element and may accordingly adjust a required minimum capacitor charge level before enabling a vaporization event.

The adjustment buttons 760 can also be used to configure power-source related behaviors. For example, in some implementations, the user can use the adjustment buttons 760 to select a conservative current limit mode for use with a smartphone power source such as an iPhone, or a higher current mode for use with a wall adapter capable of supplying greater power.

The example body portion 710 of FIG. 7 can also include internal structural features that are not visible in the figure. These internal features may include standoffs for securing a printed circuit board, channels for routing internal wiring between the power connector 720, the cartridge connector 740, and the various buttons and indicator light, as well as features for supporting an internal reservoir when the device is configured as an integrated direct-connect cartridge similar to the cartridge 420 of FIG. 4.

For example, the same general exterior configuration shown for the body portion 710 can be used for a device in which the portable inhalation device 640 of FIG. 6 is integrated within the housing. In that example, the cartridge connector 740 can act as an opening to a fixed internal reservoir rather than a receptacle for a removable cartridge, while the internal capacitor and power conditioning circuitry can be arranged along the length of the body portion 710.

The power connector 720, operation button 730, cartridge connector 740, indicator light 750, and adjustment buttons 760 may be arranged on the body portion 710 in other patterns. For example, the operation button 730 can be relocated to a side of the body portion 710, and the indicator light 750 can be placed nearer to the cartridge connector 740 so that the user can readily view the indicator while observing the attached cartridge.

In some examples, the power connector 720 can be implemented as a recessed port rather than a protruding plug. For example, the power connector 720 may include a USB-C receptacle flush with a lower surface of the body portion 710, and the user can then couple an external cable between this receptacle and an external power source. The same general housing shown in FIG. 7 can thus support both plug-type and port-type power connectors in different model variations.

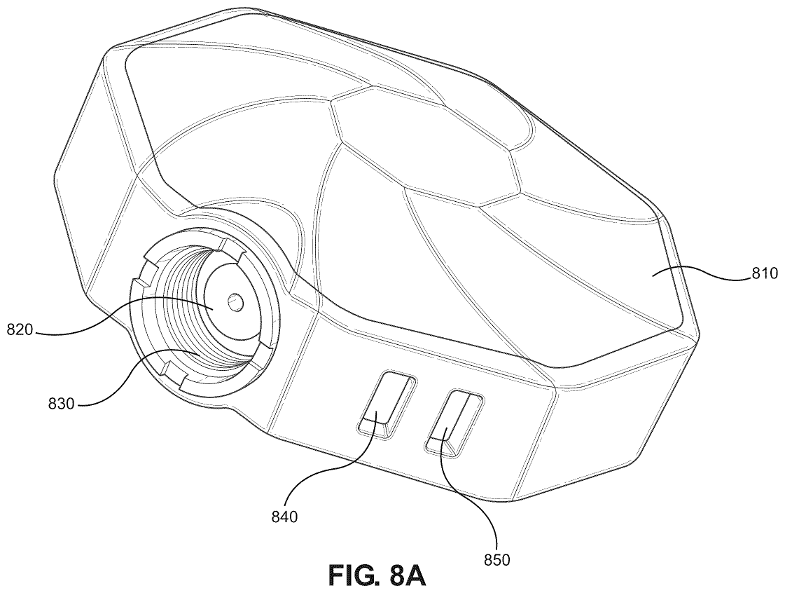

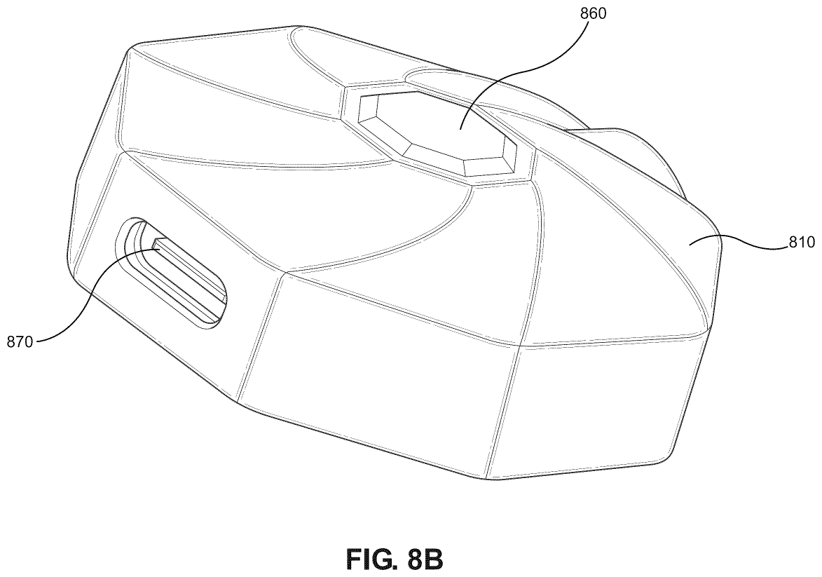

FIGS. 8A and 8B provide different perspective views of an example handheld adapter device that can integrate one or more of the external-power and cartridge-connection features described above. The two figures show different sides of the same example device so that exterior functional regions and their relative positions on a common body portion can be understood together.

In the example of FIG. 8A, a body portion 810 may be provided. The body portion 810 can define an exterior shell that encloses internal circuitry such as power conditioning circuitry similar to the circuitry 520 of FIG. 5 or the circuitry 620 of FIG. 6. The body portion 810 may have a multifaceted geometry. For example, the body portion 810 can include a set of planar facets that intersect along edges so that the device can rest on a table without rolling. The body portion 810 may be formed from plastic, metal, or a composite material so that it may provide mechanical strength and thermal management for components within the device.

A connector element 820 may be formed in a lower region of the body portion 810 in FIG. 8A. The connector element 820 can define an opening that extends inwardly from an exterior surface of the body portion 810. For example, the connector element 820 can be a circular recess that receives a threaded connector 830. The connector element 820 may be centered on a sloping facet so that a user can view and access the connector from multiple angles while plugging the device into a power source or while coupling the device to a cartridge.

The threaded connector 830 may be positioned within the connector element 820. In an example, the threaded connector 830 can include internal threads configured to receive an external male connector of a portable inhalation device such as the cartridge 320 of FIG. 3. The threaded connector 830 may define a 510-type connection so that existing cartridges can be used. For example, the threaded connector 830 can present a central positive contact and a surrounding threaded ground contact so that electrical power from a capacitor similar to the capacitor 630 of FIG. 6 can be delivered to a heating element within a coupled cartridge. In other examples, the threaded connector 830 may be replaced by or combined with a magnetic or push-fit connector so that various cartridge formats can be supported.

One or more indicators 840 and 850 may be positioned on a side surface of the body portion 810 in FIG. 8A. Each of the indicators 840 and 850 can be implemented as a light-emitting region that connects optically to an internal LED similar to the indicator light described with respect to the device 610 of FIG. 6. For example, the indicator 840 can be configured to provide feedback regarding a charging state of an internal capacitor. The indicator 840 may emit a first pattern when the device is drawing power from an external source through a power connector similar to the power connector 720 of FIG. 7. The indicator 840 may emit a second pattern when a capacitor has reached a threshold charge suitable for a vaporization event. The indicator 850 can be configured to provide information regarding an active discharge state or a detected fault state. For example, the indicator 850 may illuminate during a vaporization cycle when an operation button similar to the operation button 730 of FIG. 7 is actuated, and may flash when an over-temperature condition is detected by internal sensors.

The indicators 840 and 850 may be spaced apart vertically along the side of the body portion 810. This spacing can allow a user to distinguish their meanings even when only peripheral vision is available. The indicators 840 and 850 may be located on a facet that faces slightly outward when the connector element 820 is coupled to a horizontal power source so that visual information remains visible to the user during charging or use.

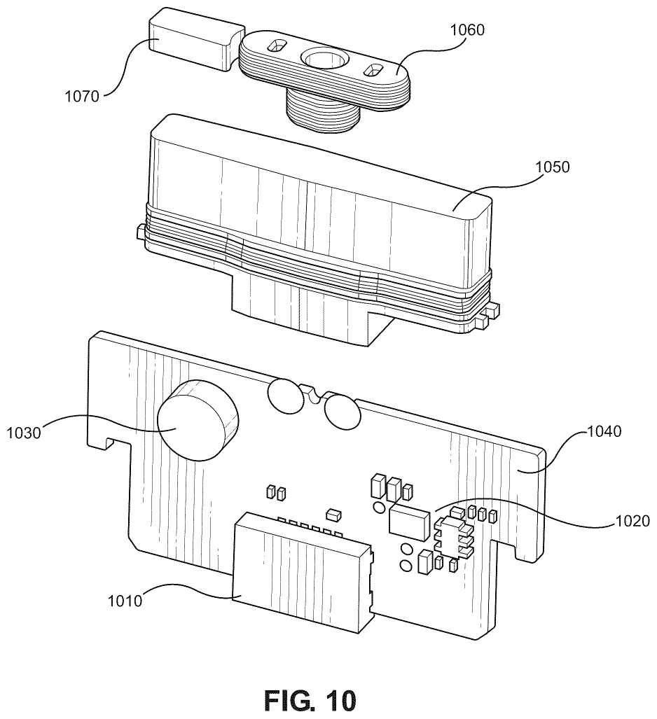

FIG. 8B shows the same example body portion 810 from another perspective. In this view, an operation button 860 may be seen on a front facet of the body portion 810. The operation button 860 can be configured to control discharge of stored capacitive energy through a cartridge that is coupled to the threaded connector 830 of FIG. 8A. For example, the operation button 860 may be a mechanical push-button that actuates a switch on an internal circuit board similar to the circuit board 1040 of FIG. 10. In another example, the operation button 860 may be a capacitive touch region that senses contact through the wall of the body portion 810. The operation button 860 may be elongated in a vertical direction so that a user can locate it by feel while holding the device without needing to look directly at the housing.

A power connector 870 may be located on a lower side region of the body portion 810 in FIG. 8B. The power connector 870 can be configured to couple the device of FIGS. 8A and 8B to an external power source similar to the external power source 670 of FIG. 6. For example, the power connector 870 may define a recessed USB-C receptacle so that an external cable can be inserted. In another example, the power connector 870 may define a slot that receives a proprietary magnetic plug. The elongated shape of the power connector 870 in FIG. 8B can indicate a keying geometry that can prevent incorrect cable orientation. The power connector 870 may be electrically coupled to internal power conditioning circuitry similar to the circuitry 520 of FIG. 5 so that electricity received from a phone or wall adapter can be converted to charge a capacitor and subsequently power a cartridge.

For example, the combination of the connector element 820, the threaded connector 830, the operation button 860, the indicators 840 and 850, and the power connector 870 on the common body portion 810 can provide an integrated adapter device. The integrated adapter device may be configured to receive power from a power-limited source through the power connector 870, condition and optionally store that power within the housing, and then deliver the conditioned or stored power through the threaded connector 830 to a removable cartridge. In this way the external geometry shown in FIGS. 8A and 8B can support internal architectures such as those described with respect to FIGS. 5 and 6 while presenting a compact, hand-held form factor that can be used comfortably by a user in a variety of orientations.

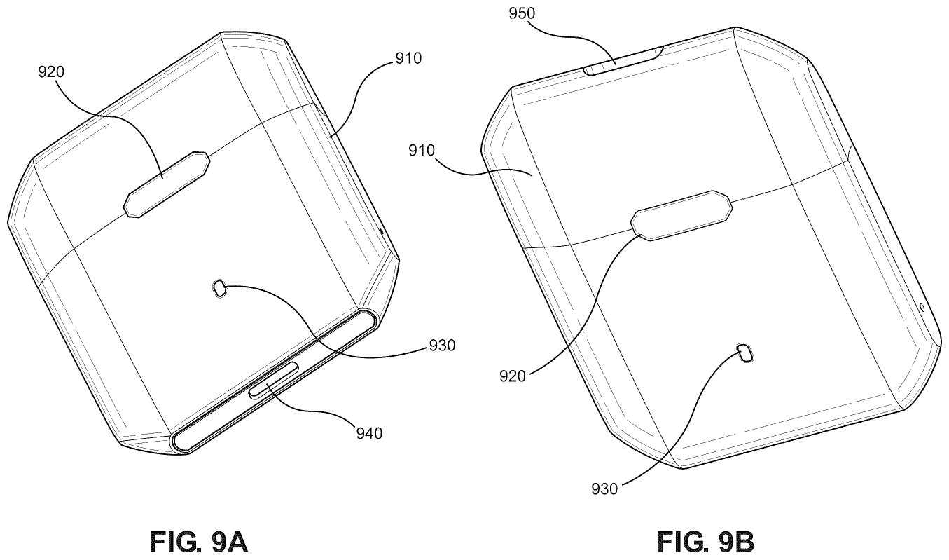

FIGS. 9A and 9B provide exterior views of an example handheld adapter device that can implement one or more of the power-conditioning and battery-less vaporization techniques described herein. FIG. 10 provides an exploded internal view of an example assembly that can be positioned within the housing shown in FIGS. 9A and 9B.

In FIG. 9A, a body portion 910 can define a shell that surrounds an internal cavity. The body portion 910 can be shaped as a generally rectangular prism with rounded corners and curved edges. For example, the body portion 910 may have a thickness that allows the device to fit comfortably in a user's palm. The body portion 910 can be formed from plastic, metal, composite material, or any combination thereof. The body portion 910 can define an open side that faces inward in the perspective of FIG. 9A. That open side can be configured to receive an internal assembly such as the assembly shown in FIG. 10. For example, the body portion 910 may include internal ledges or bosses that can support a circuit board 1040 and other components.

An operation button 920 can be exposed on an exterior face of the body portion 910. The operation button 920 can be formed as an elongated recessed region with a rounded-rectangle outline. For example, the operation button 920 may be located near a central region of one broad face of the body portion 910 so that a user thumb can easily reach it during handheld use. The operation button 920 can be configured to mechanically or electrically couple to a switch on the circuit board 1040 of FIG. 10. The operation button 920 can be configured to send a control signal that may trigger a charging mode, a discharge mode, or both. For example, a short press of the operation button 920 can be interpreted as a request to begin a vaporization discharge, while a longer press can be interpreted as a request to enter or exit a trickle-charging mode.

A small aperture on the body portion 910 can be designated as an indicator light 930 in FIG. 9A. The indicator light 930 may correspond to an LED mounted on the circuit board 1040. For example, the indicator light 930 can emit different colors or blink patterns to indicate charging state, discharge state, or fault conditions associated with the power conditioning circuitry 1020 and capacitor 1030 of FIG. 10.

In FIG. 9A, a cutout along one side wall of the body portion 910 can define a power connector 940. The power connector 940 can expose a port, plug, or other interface that may couple the device to an external power source similar to the external power source 560 or 670 described with respect to FIGS. 5 and 6. For example, the power connector 940 can be a USB-C receptacle mounted to the circuit board 1040, or a window through which a board-mounted USB-A or USB-C plug 1010 can protrude. For example, the power connector 940 can be configured so that the device of FIGS. 9A and 9B can be connected to a mobile phone, tablet, laptop, wall adapter, or vehicle charger. The power connector 940 may be aligned with the power connector 1010 of FIG. 10 so that mechanical loads incurred during plugging and unplugging can be transferred into the body portion 910.

FIG. 9B shows a different perspective of the same body portion 910. In FIG. 9B, the operation button 920 can again be visible on a broad external face of the body portion 910. The indicator light 930 can be visible as a slot or small opening separate from the operation button 920. For example, the indicator light 930 may be positioned closer to an upper end of the body portion 910 than the operation button 920.

An inhalation port 950 can be formed at an end region of the body portion 910 in FIG. 9B. The inhalation port 950 can define an airflow opening through which a user can draw vapor produced by a heating element 1060 of FIG. 10. For example, the inhalation port 950 may align with an internal vapor pathway that extends from an internal reservoir 1050 and the heating element 1060 toward the exterior of the device.

The inhalation port 950 can be coupled to a removable mouthpiece in some examples. The mouthpiece can snap into or over the inhalation port 950. In other examples, the inhalation port 950 can itself form an integrated mouth-contact region with a smooth, rounded contour. For example, the device of FIGS. 9A and 9B may operate as a compact, all-in-one adapter that can receive power via the power connector 940, store energy internally, and provide vapor at the inhalation port 950 when the operation button 920 is actuated. The indicator light 930 can provide visual feedback during each phase of this process.

FIG. 10 provides an exploded perspective view of internal components that can be installed within the body portion 910 shown in FIGS. 9A and 9B. A power connector 1010 can be mounted near an edge region of a circuit board 1040. The power connector 1010 may be any connector configured to receive power from a power source. For example, the power connector 1010 can be a USB-C receptacle, a USB-A plug, a Lightning connector, or another standardized or proprietary power interface.

The circuit board 1040 can support power conditioning circuitry 1020. The power conditioning circuitry 1020 can include any combination of regulators, converters, controllers, switches, and protection elements similar to the circuitry 520 or 620 described with respect to FIGS. 5 and 6. For example, the power conditioning circuitry 1020 may be configured to limit current drawn through the power connector 1010 from a smartphone to a safe level such as 900 mA at 5 V, and to negotiate available power levels using USB Power Delivery signaling.

The power conditioning circuitry 1020 can be configured to charge a capacitor 1030 that is also mounted on the circuit board 1040. The capacitor 1030 can be a discrete cylindrical component, as suggested by the circular shape in FIG. 10. For example, the capacitor 1030 can be a super-capacitor capable of storing tens of joules of energy at a few volts so that a short, high-power discharge may be delivered to the heating element 1060.

In some examples, the capacitor 1030 can be a bank of multiple capacitors arranged in series, in parallel, or both, where the bank can be collectively indicated by the reference number 1030 in FIG. 10. For example, multiple capacitors can share a common mounting footprint and may be potted together, so that they appear roughly as a single feature at the level of FIG. 10.

The circuit board 1040 can also support control electronics such as a microcontroller, gate drivers, current sensors, and temperature sensors that can form a portion of the power conditioning circuitry 1020. For example, the microcontroller can receive a signal from a switch associated with the operation button 920, determine whether the capacitor 1030 contains sufficient charge, and then enable or disable discharge into the heating element 1060 accordingly.

Above the circuit board 1040 in FIG. 10, an internal reservoir 1050 may be provided. The internal reservoir 1050 can define a cavity for holding a vaporizable material similar to the material 550 or 660 in FIGS. 5 and 6. For example, the internal reservoir 1050 can be a molded plastic or metal shell that attaches to the circuit board 1040 by fasteners, clips, or adhesive.

The internal reservoir 1050 can be sized and shaped so that, when assembled into the body portion 910, it aligns with the inhalation port 950 shown in FIG. 9B. The internal reservoir 1050 may include an internal channel or chimney that routes vapor from the heating element 1060 toward the inhalation port 950. For example, the internal reservoir 1050 can be coupled to a wick that draws liquid from a storage chamber toward a region beneath the heating element 1060.

A heating element 1060 can be provided above the internal reservoir 1050. The heating element 1060 can include a metal or ceramic structure with an embedded resistive heater. For example, the heating element 1060 may include a threaded collar that can be received into a matching threaded opening in the internal reservoir 1050 so that liquid or other vaporizable material can contact a wick in thermal communication with the resistive heater.

The heating element 1060 can be configured to receive electrical energy from the capacitor 1030 through traces on the circuit board 1040 and through conductive elements that extend into the region defined by the internal reservoir 1050. For example, spring contacts on the underside of the heating element 1060 may engage with pads on the circuit board 1040 so that the capacitor 1030 can discharge through the heating element 1060 when the control circuitry 1020 enables a discharge path.

For example, when the user presses the operation button 920, the control circuitry 1020 can close a MOSFET so that current from the capacitor 1030 flows into the heating element 1060. The internal reservoir 1050 can then supply liquid to the heating element 1060, which may vaporize that liquid. The vapor can then travel through an internal passage of the heating element 1060, across the internal reservoir 1050, and out through the inhalation port 950.

An auxiliary element 1070 can be positioned near the heating element 1060 in FIG. 10. The auxiliary element 1070 can be configured for various purposes. For example, the auxiliary element 1070 may be a temperature sensor that can contact the heating element 1060 or the internal reservoir 1050 to provide real-time temperature data to the power conditioning circuitry 1020 on the circuit board 1040. In some examples, the auxiliary element 1070 performs reservoir functions by holding vaporizable material that is vaporized by the heating element 1060.

In another example, the auxiliary element 1070 can be a mechanical spacer, seal, or gasket that can be compressed between the heating element 1060 and the internal reservoir 1050 to prevent leakage of liquid or vapor. For example, the auxiliary element 1070 may be an elastomeric ring that also provides electrical insulation between different regions of the heating element 1060.

The auxiliary element 1070 can alternatively be an additional electrical subassembly such as a secondary indicator, a vibration motor, or a small secondary capacitor. For example, the auxiliary element 1070 can be configured to store a small amount of energy separate from the capacitor 1030 so that the indicator light 930 can remain illuminated briefly even after the main discharge path to the heating element 1060 has been disabled.

The relative vertical stacking of the circuit board 1040, internal reservoir 1050, heating element 1060, and auxiliary element 1070 in FIG. 10 may correspond to a vertical stacking within the body portion 910 of FIGS. 9A and 9B. For example, the circuit board 1040 can rest near the open side of the body portion 910, the internal reservoir 1050 can be centered within the cavity, and the heating element 1060 can be placed near the inhalation port 950.

For example, the power connector 1010 may align with the opening for the power connector 940, the indicator LED associated with the indicator light 930 can align with the small aperture labeled 930, and a tactile switch on the circuit board 1040 can align with the operation button 920. This spatial alignment can allow the body portion 910 to protect and conceal the internal components while still exposing functional interfaces to the user and to external power sources.

In other examples, the internal reservoir 1050 of FIG. 10 may not store vaporizable material and can instead function as a cartridge bay or receptacle configured to receive a removable cartridge. In such an example, the heating element 1060 can form part of the removable cartridge, and the capacitor 1030 and power conditioning circuitry 1020 can remain within the body portion 910 as a reusable power module.

Other configurations of the example device of FIGS. 9A, 9B, and 10 may be implemented. For example, the capacitor 1030 can be relocated to a different portion of the circuit board 1040, or multiple capacitors 1030 can be distributed around the internal reservoir 1050 to balance mass and thermal effects, while still remaining electrically coupled to the power conditioning circuitry 1020 and to the heating element 1060 through conductive traces or wires.

Other examples of the disclosure will be apparent to those skilled in the art from consideration of the specification and practice of the examples disclosed herein. Though some of the described methods have been presented as a series of steps, it should be appreciated that one or more steps can occur simultaneously, in an overlapping fashion, or in a different order. The order of steps presented are only illustrative of the possibilities and those steps can be executed or performed in any suitable fashion. Moreover, the various features of the examples described here are not mutually exclusive. Rather any feature of any example described here can be incorporated into any other suitable example. It is intended that the specification and examples be considered as exemplary only, with a true scope and spirit of the disclosure being indicated by the following claims.

What is claimed is:

1. An adapter device for powering a portable inhalation device, comprising:
a power-side connector configured to be coupled to a power source;
a device-side connector configured to be coupled to the portable inhalation device; and
a power adapter configured to condition electricity received from the power source such that the electricity is usable by the portable inhalation device,
wherein the portable inhalation device uses the conditioned electricity from the power adapter, rather than chemical-battery power, to vaporize a substance for inhalation.

2. The adapter device of claim 1, wherein the portable inhalation device is at least one of a cartridge that houses vaporizable material for inhalation, and a vaporizer device configured to vaporize material for inhalation.

3. The adapter device of claim 1, wherein the power source is a mobile phone.

4. The adapter device of claim 3, wherein the power adapter is configured to determine a threshold energy-draw rate from the mobile phone and receive power from the mobile phone in accordance with the threshold.

5. The adapter device of claim 1, wherein the adapter device is connected to the portable inhalation device using a power cable.

6. The adapter device of claim 5, wherein the power cable is permanently fixed to at least one of the power-side connector and the power source.

7. The adapter device of claim 1, wherein the adapter device is positioned within a body portion of the portable inhalation device.

8. The adapter device of claim 1, wherein the portable inhalation device includes a heating element.

9. A device for powering a portable inhalation device without using a chemical-based battery, the device comprising:
a power-side connector configured to be coupled to a power source;
a device-side connector configured to be coupled to the portable inhalation device; and
a capacitor configured to store energy received from the power source and dispense the stored energy to the portable inhalation device,
wherein the portable inhalation device is configured to vaporize a material based on the stored energy dispersed from the capacitor.

10. The device of claim 9, wherein the portable inhalation device is at least one of a cartridge that houses vaporizable material for inhalation, and a vaporizer device configured to vaporize material for inhalation.

11. The device of claim 9, wherein the power source is a mobile phone.

12. The device of claim 11, wherein the device is configured to determine a threshold energy-draw rate from the mobile phone and receive power from the mobile phone in accordance with the threshold.

13. The device of claim 9, wherein the capacitor is positioned within a body portion of the portable inhalation device.

14. The device of claim 9, wherein the capacitor is at least one of a super capacitor, dielectric capacitor, electrolytic capacitor, and ceramic capacitor.

15. A method for powering a portable inhalation device without battery power, the method comprising:
coupling an adapter device to a power source;
conditioning, by the adapter device, electricity received from the power source; and
providing the conditioned electricity to a portable inhalation device,
wherein the portable inhalation device uses the conditioned electricity from the power adapter, rather than battery power, to vaporize a substance for inhalation.

16. The method of claim 15, further comprising decoupling the adapter device from the power source before providing the conditioned electricity to the portable inhalation device.

17. The method of claim 16, wherein providing the conditioned electricity is performed by a capacitor.

18. The method of claim 15, further comprising determining a threshold power draw rate for the power source, wherein conditioning electricity comprises drawing electricity from the power source at a rate that does not exceed the threshold power draw rate for the power source.

19. The method of claim 15, further comprising trickle-charging the adapter device by the power source.

20. The method of claim 15, further comprising inserting a power cord into at least one of the adapter device and the power source.
